(19) United States
(12) Patent Application Publication
(10) Pub. No.: US 2005/0171934 A1
(43) Pub. Date: Aug. 4, 2005

(54) System and method for generating a parameterized query

(76) Inventors: Paul Yuknewicz, Redmond, WA (US); Antoine Cote, Redmond, WA (US)

Correspondence Address: WOODCOCK WASHBURN LLP, ONE LIBERTY PLACE - 46TH FLOOR, PHILADELPHIA, PA, 19103, US

(21) Appl. No.: 10/768,525

(22) Filed: Jan. 30, 2004

(51) Int. Cl. G06F 7/00

(52) U.S. Cl. 707/3

(57) ABSTRACT

A user may select a dataset and choose whether to select an existing parameterized query or to define a new parameterized query to execute upon the selected dataset. If the user chooses to select an existing parameterized query, then a set of existing parameterized queries corresponding to the dataset may be identified and displayed to the user. If the user chooses to define a new parameterized query, then the new parameterized query may easily be merged into the set of existing parameterized queries corresponding to the dataset. In response to the generation of a parameterized query, input fields may be readily provided that enable the user to set the value of query parameters. Thus, the user may easily and efficiently add searching and filtering capabilities in connection with an application.

### REFERENCE TO RELATED APPLICATIONS

This application is related by subject matter to U.S. patent application (Ser. No. unknown) entitled “System and Method for Providing a Logical View of a Data Source” filed on Jan. 30, 2004 (Attorney Docket Number MSFT-2945, Client Docket Number 307293.01), U.S. patent application (Ser. No. unknown) entitled “System and Method for Exposing a Child List” filed on Jan. 30, 2004 (Attorney Docket Number MSFT-2959, Client Docket Number 307291.01), and U.S. patent application (Ser. No. unknown) entitled “System and Method for Exposing Tasks in a Development Environment” filed on Jan. 30, 2004 (Attorney Docket Number MSFT-2961, Client Docket Number 307290.01), the contents of which are hereby incorporated by reference in their entirety.

### FIELD OF THE INVENTION

The present invention relates to the field of data retrieval and manipulation and, more specifically, to generating a parameterized query to retrieve selected data from a data source.

### BACKGROUND OF THE INVENTION

A development tool such as, for example, VISUAL STUDIO™ from Microsoft Corp. of Redmond, Wash., enables development of a wide range of computing applications. Such applications may include, for example, web applications, extensible markup language (XML) applications, and traditional client applications. An application may have one or more associated data sources. Such data sources may be for example, databases, web services, extensible markup language (XML) documents, and objects. Such data sources may be used to categorize, organize, and maintain datasets that are useful to an application. To assist in the development process, the development tool enables the user to view, manage, and manipulate datasets within such data sources. The term dataset, as used herein, refers to a collection of data such as, for example, a data table or a list.

Rather than retrieving and working with an entire dataset, it is often desirable for a user to work with only a selected portion of a dataset. Such a selected portion may include data that corresponds to a particular data parameter. For example, rather than working with data for all customers, it may be desirable for the user to work only with data for customers named John. Thus, the user may filter a “Customers” dataset to retrieve only data that satisfies the parameter “Customer-Name=‘John’”. There are a number of conventional methods by which a user may filter a dataset within a development environment.

In one such conventional method, the user may retrieve an entire dataset from a data source and then use a development tool to filter the desired data portion from the entire retrieved dataset. This approach involves a number of drawbacks. For example, as datasets may often be quite large and may possibly include dense and highly complex data objects, retrieving an entire dataset from a data source may be a time consuming process which requires a significant amount of network bandwidth. Additionally, filtering the dataset at the development tool or in an application may also be a time consuming process which delays and/or slows the performance of the application and other important developer tasks.

To avoid the drawbacks set forth above and possibly other associated drawbacks, it may often be desirable for the user generate a parameterized query for identifying and retrieving only a selected portion of a dataset from a data source. Such a parameterized query enables the database, rather than the development tool, to filter the dataset for the selected data. Filtering the dataset at the database takes advantage of the advanced data sorting and filtering capabilities of most conventional databases. Filtering the dataset at the database also improves application efficiency by enabling the development tool to perform other tasks rather than sorting and filtering data.

While, conventional development tools may enable a user to generate such a parameterized query, their capabilities are limited. For example, conventional development tools do not readily provide a user with information about existing parameterized queries. Thus, if the user wishes to determine which existing parameterized queries are available to be executed upon a particular dataset, then the user is required to conduct a manual search of a query schema. Additionally, when the user defines a new parameterized query to be executed upon a dataset, conventional development tools do not enable the user to easily associate the new parameterized query with the dataset and store the parameterized query in the query schema. Furthermore, conventional development tools do not readily enable the user to set the value of query parameters. Thus, to set query parameters, the user may be required to manually generate parameter input fields and then write code to associate values entered in the input fields with the query.

Thus, there is a need in the art for systems and methods for efficiently generating a parameterized query. It is desired that such systems and methods enable a user to select a dataset and to choose whether to select an existing parameterized query or to define a new parameterized query to execute upon the selected dataset. If the user chooses to select an existing parameterized query, it is desired that a set of existing parameterized queries corresponding to the dataset be identified and displayed to the user. If the user chooses to define a new parameterized query, it is desired that the new parameterized query may be easily merged into the set of existing parameterized queries corresponding to the dataset. It is further desired that, in response to the generation of a parameterized query, input fields are readily provided that enable the user to set the value of query parameters. Systems and methods with these and other characteristics may enable a user to easily and efficiently add searching and filtering capabilities in connection with an application.

### SUMMARY OF THE INVENTION

Systems and methods for generating a parameterized query are disclosed. The parameterized query may include a query parameter that is set by a user to retrieve a selected portion of a dataset.

According an aspect of the invention, an interface may be provided that enables a user to select a dataset for which to generate the parameterized query. The interface may also enable the user to choose whether to define a new parameterized query or to select an existing parameterized query.

If the user chooses to define a new parameterized query, then an input field may be provided in which the user may define the new parameterized query. To assist the user, a sample query may be displayed that provides an exemplary format specific query structure including an exemplary query parameter. Once defined, the new query may optionally be merged into a schema metadata file. The newly defined query may also be validated by, for example, determining that the query parameter corresponds to an existing portion of the dataset and that the query includes proper syntax.

If the user chooses to select an existing parameterized query, then a set of existing parameterized queries and stored procedures associated with the dataset may be identified and displayed. The set of existing parameterized queries may be stored in the schema metadata file. The interface may enable the user to select a particular query from the set of existing parameterized queries. A default parameterized query associated with the dataset may be identified and displayed to the user as a default selection in the interface.

According to another aspect of the invention, an input field may be provided that enables the user to set the query parameter. Once the parameter is set, code may then be generated for calling and executing the parameterized query with the set query parameter. Upon execution of the query, a display object may be populated with the results of the executed parameterized query.

According to another aspect of the invention, a stored procedure may be generated in place of or in addition to parameterized query to retrieve a desired portion of a dataset.

Additional features and advantages of the invention will be made apparent from the following detailed description of illustrative embodiments that proceeds with reference to the accompanying drawings.

### BRIEF DESCRIPTION OF THE DRAWINGS

The illustrative embodiments will be better understood after reading the following detailed description with reference to the appended drawings, in which:

FIG. 1 is a block diagram representing a general purpose computer system in which aspects of the present invention and/or portions thereof may be incorporated;

FIG. 2 is a block diagram of an exemplary development environment in accordance with the present invention;

FIG. 3 shows an exemplary form in accordance with the present invention;

FIG. 4 shows an exemplary designer interface in accordance with the present invention;

FIG. 5 shows an exemplary parameterized query builder dialog box in accordance with the present invention;

FIG. 6 shows an exemplary form with an empty parameter input field in accordance with the present invention;

FIG. 7 shows an exemplary form with a set parameter input field in accordance with the present invention;

FIG. 8 shows an exemplary parameterized query builder dialog box in accordance with the present invention;

FIG. 9 shows an exemplary form with an empty parameter input field in accordance with the present invention;

FIG. 10 shows an exemplary form with a set parameter input field in accordance with the present invention; and

FIG. 11 shows a flowchart of an exemplary method for generating a parameterized query in accordance with the present invention.

### DETAILED DESCRIPTION OF ILLUSTRATIVE EMBODIMENTS

The subject matter of the present invention is described with specificity to meet statutory requirements. However, the description itself is not intended to limit the scope of this patent. Rather, the inventors have contemplated that the claimed subject matter might also be embodied in other ways, to include different steps or elements similar to the ones described in this document, in conjunction with other present or future technologies. Moreover, although the term “step” may be used herein to connote different aspects of methods employed, the term should not be interpreted as implying any particular order among or between various steps herein disclosed unless and except when the order of individual steps is explicitly described.

We will now explain the present invention with reference to presently preferred, exemplary embodiments. We will first describe illustrative computing and development environments in which the invention may be practiced, and then we will describe presently preferred implementations of the invention.

Illustrative Computer Environment

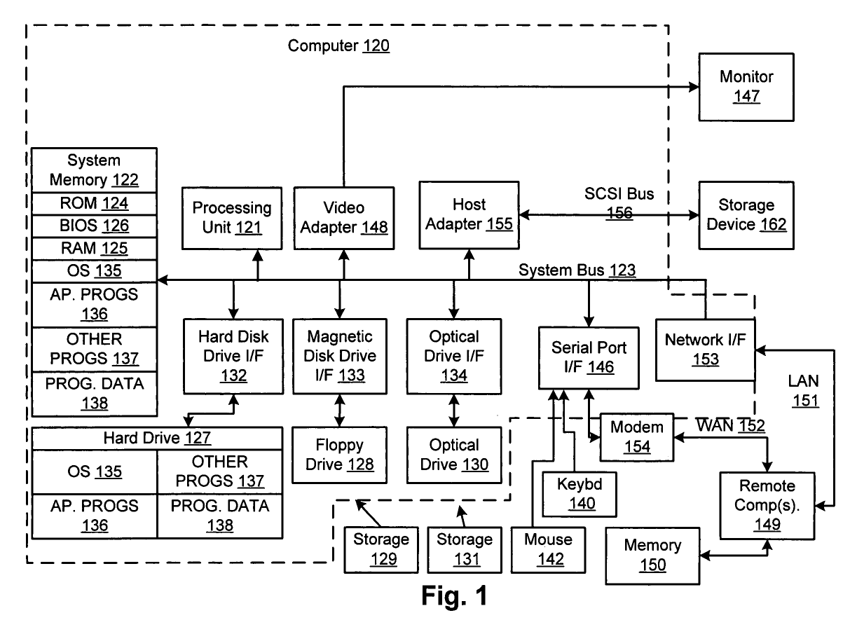

FIG. 1 and the following discussion are intended to provide a brief general description of a suitable computing environment in which the present invention and/or portions thereof may be implemented. Although not required, the invention is described in the general context of computer-executable instructions, such as program modules, being executed by a computer, such as a client workstation or an application service. Generally, program modules include routines, programs, objects, components, data structures and the like that perform particular tasks or implement particular abstract data types. Moreover, it should be appreciated that the invention and/or portions thereof may be practiced with other computer system configurations, including hand-held devices, multi-processor systems, microprocessor-based or programmable consumer electronics, network PCs, minicomputers, mainframe computers and the like. The invention may also be practiced in distributed computing environments where tasks are performed by remote processing devices that are linked through a communications network. In a distributed computing environment, program modules may be located in both local and remote memory storage devices.

As shown in FIG. 1, an exemplary general purpose computing system includes a conventional personal computer 120 or the like, including a processing unit 121, a system memory 122, and a system bus 123 that couples various system components including the system memory to the processing unit 121. The system bus 123 may be any of several types of bus structures including a memory bus or memory controller, a peripheral bus, and a local bus using any of a variety of bus architectures. The system memory includes read-only memory (ROM) 124 and random access memory (RAM) 125. A basic input/output system 126 (BIOS), containing the basic routines that help to transfer information between elements within the personal computer 120, such as during start-up, is stored in ROM 124.

The personal computer 120 may further include a hard disk drive 127 for reading from and writing to a hard disk (not shown), a magnetic disk drive 128 for reading from or writing to a removable magnetic disk 129, and an optical disk drive 130 for reading from or writing to a removable optical disk 131 such as a CD-ROM or other optical media. The hard disk drive 127, magnetic disk drive 128, and optical disk drive 130 are connected to the system bus 123 by a hard disk drive interface 132, a magnetic disk drive interface 133, and an optical drive interface 134, respectively. The drives and their associated computer-readable media provide non-volatile storage of computer readable instructions, data structures, program modules and other data for the personal computer 120.

Although the exemplary environment described herein employs a hard disk, a removable magnetic disk 129, and a removable optical disk 131, it should be appreciated that other types of computer readable media which can store data that is accessible by a computer may also be used in the exemplary operating environment. Such other types of media include a magnetic cassette, a flash memory card, a digital video disk, a Bernoulli cartridge, a random access memory (RAM), a read-only memory (ROM), and the like.

A number of program modules may be stored on the hard disk, magnetic disk 129, optical disk 131, ROM 124 or RAM 125, including an operating system 135, one or more application 212 programs 136, other program modules 137 and program data 138. A user may enter commands and information into the personal computer 120 through input devices such as a keyboard 140 and pointing device 142 such as a mouse. Other input devices (not shown) may include a microphone, joystick, game pad, satellite disk, scanner, or the like. These and other input devices are often connected to the processing unit 121 through a serial port interface 146 that is coupled to the system bus, but may be connected by other interfaces, such as a parallel port, game port, or universal serial bus (USB). A monitor 147 or other type of display device is also connected to the system bus 123 via an interface, such as a video adapter 148. In addition to the monitor 147, a personal computer typically includes other peripheral output devices (not shown), such as speakers and printers. The exemplary system of FIG. 1 also includes a host adapter 155, a Small Computer System Interface (SCSI) bus 156, and an external storage device 162 connected to the SCSI bus 156 The personal computer 120 may operate in a networked environment using logical connections to one or more remote computers, such as a remote computer 149. The remote computer 149 may be another personal computer, a application service, a router, a network PC, a peer device or other common network node, and typically includes many or all of the elements described above relative to the personal computer 120, although only a memory storage device 150 has been illustrated in FIG. 1. The logical connections depicted in FIG. 1 include a local area network (LAN) 151 and a wide area network (WAN) 152. Such networking environments are commonplace in offices, enterprise-wide computer networks, intranets, and the Internet.

When used in a LAN networking environment, the personal computer 120 is connected to the LAN 151 through a network interface or adapter 153. When used in a WAN networking environment, the personal computer 120 typically includes a modem 154 or other means for establishing communications over the wide area network 152, such as the Internet. The modem 154, which may be internal or external, is connected to the system bus 123 via the serial port interface 146. In a networked environment, program modules depicted relative to the personal computer 120, or portions thereof, may be stored in the remote memory storage device. It will be appreciated that the network connections shown are exemplary and other means of establishing a communications link between the computers may be used.

Systems and Methods of the Present Invention

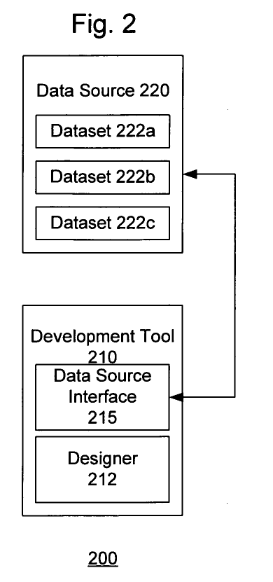

An exemplary development environment 200 in accordance with the present invention is shown in FIG. 2. Generally, development tool 210 enables the development of computing applications. Data source 220 operates in connection with development tool 210 to categorize, organize, and maintain data that is useful to applications. Data source 210 may be for example, a database, a web service, an extensible markup language (XML) document, or an object.

Data source 220 includes Customers datasets 222a, Orders dataset 222b, and Employees dataset 222c. The term dataset, as used herein, refers to a collection of data such as, for example, a data table or a list. As should be appreciated, data source 222 may include any number of datasets each including any type of data in addition to or in place of datasets 222a-c. “Customers” dataset 222a includes a number of records each corresponding to a particular customer. Exemplary data for Customers dataset 222a is shown below in Table 1:

TABLE 1

| Customer ID | Name | Zip Code |
|---|---|---|
| 1 | John | 00001 |
| 2 | Ted | 00001 |
| 3 | John | 00002 |

As shown in Table 1, the Customers dataset 222a has three columns which correspond to three customer attributes: customer ID, name, and zip code. Customers dataset 222a includes three records for Customers “1”, “2”, and “3”.

Importantly, data source 220 and, in particular, dataset 222a may be accessed by development tool 210 via a data source interface 215. Data source interface 215 may provide a logical view of the schema of data source 220, as described in detail in the aforementioned U.S. patent application (Ser. No. unknown) entitled “System and Method for Providing a Logical View of a Data Source”.

Data source interface 215 may be used in connection with designer 212, which is an interface that enables the user to create, view, manage, and manipulate objects associated with a development project. Such objects may include forms and controls. A form is an object that enables the presentation of information to the user and the acceptance of input information from the user. A form may expose properties which define its appearance, methods which define its behavior, and events which define its interaction with the user. By setting its properties and writing code to respond to its events, a user may customize a form to meet the requirements of an application. A simple way to define a user interface for a form is to place controls on the form's surface.

A control is an object that is contained within a form. A control may be an object such as, for example, a data grid view, a drop down list, a combo-box, a button, or a check-box. Each type of control has its own set of properties, methods, and events that make it suitable for a particular purpose. The designer 212 enables a user to add controls to a form. For example, the designer 212 may enable a control to be added to a form by dragging and dropping the control from a toolbox, double clicking on the control in a toolbox, or selecting the control in a toolbox and lassoing an area in the form. Once a control is added to a from, the designer 212 enables the control to be aligned and positioned within the form.

An important feature of designer 212 is that objects in the designer 212 may be bound to datasets within data source 220. For example, a form in the designer 212 may be bound to Customers dataset 222a. There are a number of methods for binding an object in the designer 212 to a dataset. For example, a dataset may be dragged from the data source interface 215 and dropped into designer 212.

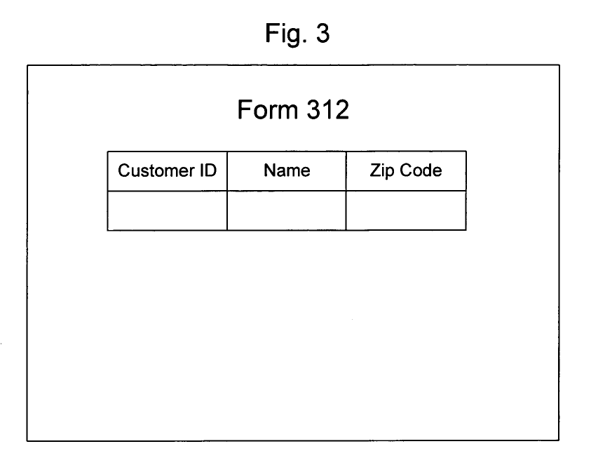

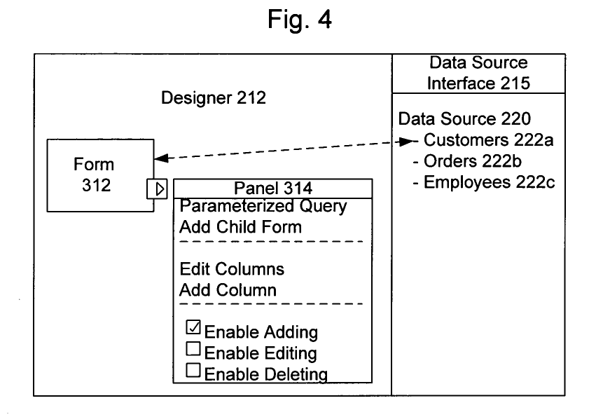

When an object in designer 212 is bound to a dataset, the object may be automatically populated with elements of the dataset such as, for example, named columns that are present within the dataset. The object may also be optionally populated with the underlying data in the dataset. Referring now to FIG. 3, form 312 is an object that is bound to Customers dataset 222a. As shown, form 312 has been populated with the named columns of Customers dataset 222a, which include, “Customer ID”, “Name”, and “Zip Code”. Such columns are identical to the columns of Customers dataset 222a as shown in Table 1. Exemplary methods for populating form 312 with portions of the underlying data from Customers dataset 222a are discussed in detail below with reference to FIGS. 4-11.

An exemplary designer 212 in accordance with the present invention is shown in FIG. 4. Designer 212 includes form 312 and also data source interface 215, which displays an exemplary schema of data source 220. Form 312 is bound to Customers dataset 222a within data source 220, as indicated by the dashed line shown in FIG. 4. Importantly, the schema shown in data source interface 215 is only a local schema that is stored at development tool 210. Underlying data source 220 may include additional elements that are not depicted in the local schema. Such underlying elements may be identified by querying data source 220 directly.

Form 312 has an associated smart user interface panel 314. Such a smart user interface panel is described in detail in the U.S. patent application (Ser. No. unknown) entitled “System and Method for Exposing Tasks in a Development Environment”. Generally, panel 314 exposes a set of exemplary developer tasks available in connection with form 312. One such task is the parameterized query task. In addition to user interface panel 430, the parameterized query task may also be exposed using, for example, a traditional menu bar or a context menu.

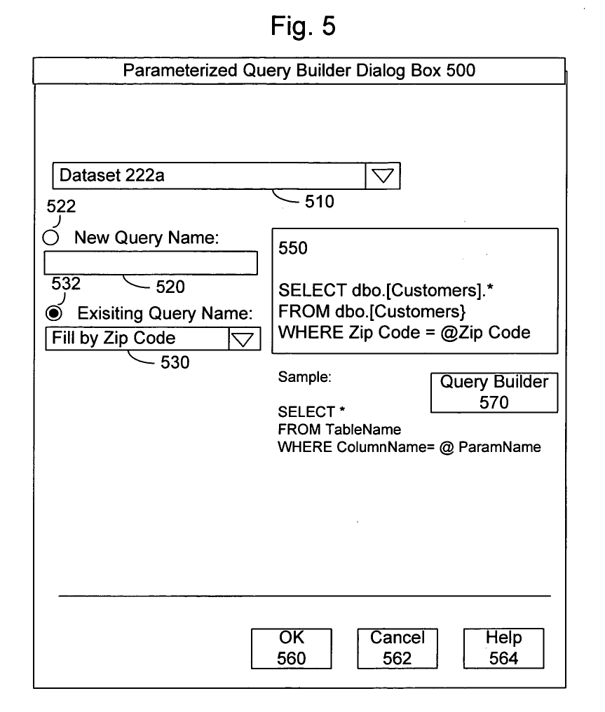

The user may select the parameterized query task by, for example, moving a screen pointer over the task item in interface panel 430 and clicking the task item with an attached mouse. Upon selecting the parameterized query task, a parameterized query dialog box or another similar interface may be displayed. Referring now to FIG. 5, exemplary parameterized query dialog box 500 includes a select dataset drop down menu 510, which enables the user to select a dataset in which the parameterized query is to be executed. As should be appreciated, other user input fields such as, for example check boxes, radio buttons, or a cascading tree display may be substituted in place of drop down menu 510 and other input fields within dialog box 500. As shown, Customers dataset 222a has been chosen as the selected dataset. Because the parameterized query task is launched from form 312, the default value of drop down menu 510 is set to “Customers” dataset 222a, the dataset to which form 312 is bound. Drop down menu 510 may also include, for example, other datasets 222b and 222c within data source 220.

Dialog box 500 also includes radio buttons 522 and 532, which enable the user to choose whether to define a new parameterized query or to select an existing parameterized query corresponding to selected Customers dataset 222a. As shown, the select existing query radio button 532 has been selected. The selection of existing query radio button 532 activates select existing parameterized query drop down menu 530, which enables the user to select a particular existing query to be executed upon Customers dataset 222a. The queries listed in drop down menu 520 may be determined by searching a schema metadata file. Such a schema metadata file may be, for example, an extensible markup language (XML) file that stores associated queries and schema information. As shown, the user has selected an existing query named “Fill be Zip Code”.

Drop down menu 530 may optionally display a default existing query associated with dataset 222a. The default query may also be identified by searching the schema metadata file. Drop down menu 530 may also display existing stored procedures associated with Customers dataset 222a, and may optionally display a default stored procedure.

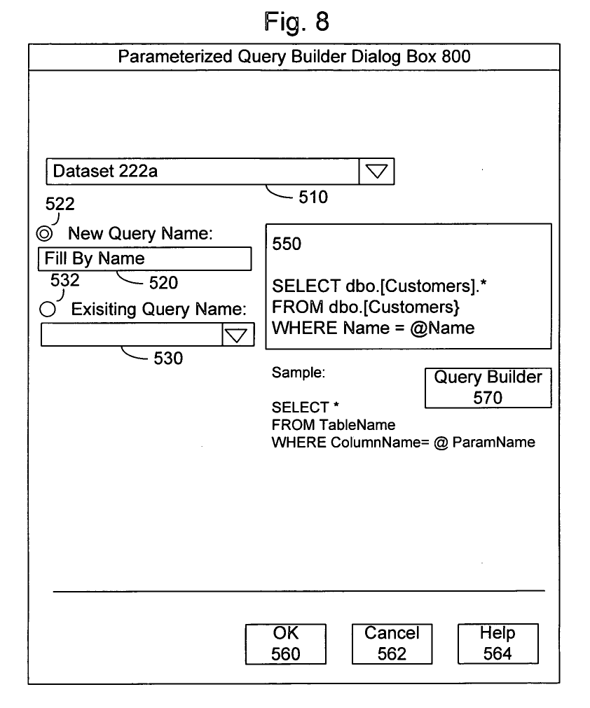

Dialog box 500 also includes new query name input field 520. As should be appreciated, input field 520 may be enabled by selecting new query radio button 522. Properties of dialog box 500 when new query radio button 522 is selected are discussed in detail below with reference to FIG. 8.

Dialog box 500 also includes parameterized query input field 550. When existing query radio button 532 is selected, input field 550 may be a read only field, which displays the existing parameterized query selected in select existing query drop down menu 530. As shown, the “Fill by Zip Code” filters Customer dataset 222a according to a zip code parameter. The code “@Zip Code” is a placeholder for the zip code parameter. As should be appreciated, although exemplary “Fill by Zip Code” query includes only a single parameter, a parameterized query in accordance with the present invention may have any number of parameters. Furthermore, a query in accordance with the present invention may include a constant that does not change. For example, the code may read “Zip Code=00001” rather than “Zip Code=@Zip Code”.

Below input field 550, dialog box 500 displays a sample query that is associated with the selected table. The sample query assists the user to interpret the query code displayed in input field 550. The sample query is written in Structured Query Language (SQL), but other query languages are contemplated in connection with the present invention. The sample query may be written in a format suitable for execution at data source 220. For example, the sample query shown in dialog box 500 has been written in a format suitable for an SQL™ database from Microsoft Corp. of Redmond, Wash. Formats for other data sources are contemplated in connection with the present invention.

Once the user has evaluated and determined that she is satisfied with the selected existing query, the user may generate the query by clicking “OK” button 560 with an attached mouse. The user may also cancel the task by clicking “cancel” button 562 or request help by clicking “Help” button 564. Upon clicking “OK” button 560, dialog box 500 may be closed and form 312 may be re-activated. Now, form 312 will include user input fields which enable the user to set the parameters of the parameterized query generated using dialog box 500. Components and code required to fetch the data corresponding to the set parameter may also be generated. For example, the development tool 210 may add a new method to a data component that takes parameters defined by the user. Development tool 210 may also generate a button on form 312 with code in a click event handler that will call the appropriate method on the generated data component. Furthermore, data components may be generated to execute parameterized queries against a specific data source. Code may then be called to execute the parameterized query on the generated data component.

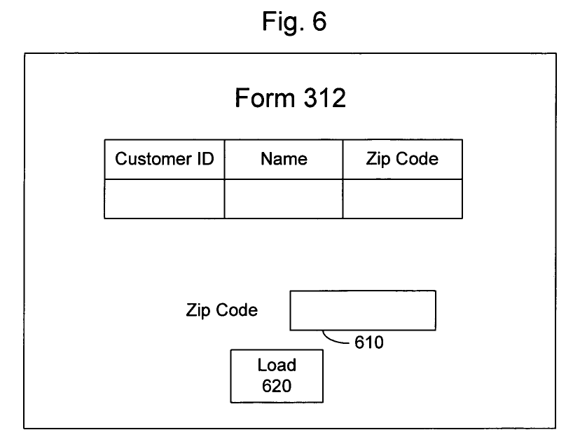

Referring now to FIG. 6, form 312 includes a parameter input field 610, which corresponds to the zip code parameter of the selected “Fill by Zip Code” query. As should be appreciated, a form in accordance with the present invention may have any number of input fields each corresponding to an input parameter. Furthermore, a form in accordance with the present invention may have no input fields if, for example, the user wishes to filter data source 220 using a constant value. Additionally, the query input parameters may be type safe parameters, meaning that the type of parameter input is validated prior to executing the query.

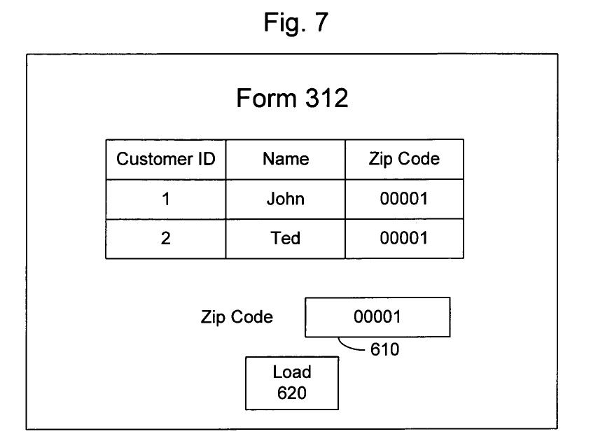

The user may enter the desired zip code in the parameter input field 610. The user may then load the parameterized query with the set input parameter by clicking “Load” button 620. When the parameterized query is loaded, the form 312 is populated with the selected portion of customers dataset 222a. Referring now to FIG. 7, Form 312 has now been populated to include records for all customers in the selected zip code. As shown, form 312 includes only those records from Table 1 with the zip code “00001”. The user may edit and manipulate data within the form, and such changes may optionally be propagated back to data source 220.

As should be appreciated, form 312 of FIG. 6 may include navigation controls to enable the user to scroll across large datasets. Furthermore, although form 312 includes a grid data display, other data displays such as, for example, a details display are contemplated in accordance with the present invention. Such a details display enables the user to scroll through records individually and to view column entries in individual fields.

The data shown in FIG. 7 is the result of an execution of an existing parameterized query. However, rather than executing an existing parameterized query, the user may often wish to define a new parameterized query. Referring now to FIG. 8, new query radio button 522 is selected to enable the user to define an existing query. The selection of new query radio button 522 activates new query name input field 520, which enables the user to name a new query. As shown, the new query has been named “Fill By Name”. The selection of new query radio button 522 may also switch parameterized query input field 550 from read only mode to read/write mode. As shown, the “Fill By Name” query is defined to filter Customer dataset 222a according to a name parameter. The code “@ name” is a placeholder for the name parameter. As should be appreciated, although exemplary “Fill by Name” query includes only a single parameter, a new parameterized query in accordance with the present invention may have any number of parameters. Furthermore, a new parameterized query in accordance with the present invention may include a constant that does not change. For example, the code may read “Name=John” rather than “Name=@Name”. Additionally, the query input parameters may be type safe parameters, meaning that the type of parameter input is validated prior to executing the query.

As with an existing query, dialog box 500 also displays a sample query. The sample query may assist the user in defining a new query. The selection of new query radio button 522 also enables query builder button 570. Query builder 570 is a feature that is present in some conventional development tools that enables the user to visually design a query.

Once the new query is defined, the new query may be validated to ensure that it may be executed upon Customers dataset 222a. For example, the “Fill by Name” query may be validated by, for example, determining that the “name”column is a column that is present in customers dataset 22a.

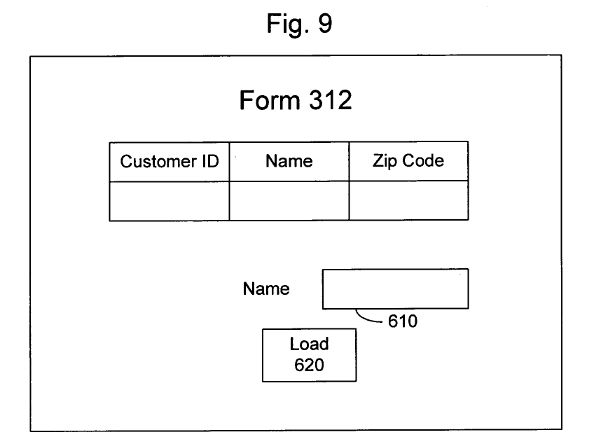

Just as with existing queries, the generation of a new query may automatically trigger a parameter input field that enables the user to set the query parameter. Referring now to FIG. 9, form 312 includes a parameter input field 610, which corresponds to the name parameter of the selected “Fill by Name” query. As should be appreciated, a form in accordance with the present invention may have any number of input fields each corresponding to an input parameter. Furthermore, a form in accordance with the present invention may have no input fields if, for example, the user wishes to filter data source 220 using a constant value.

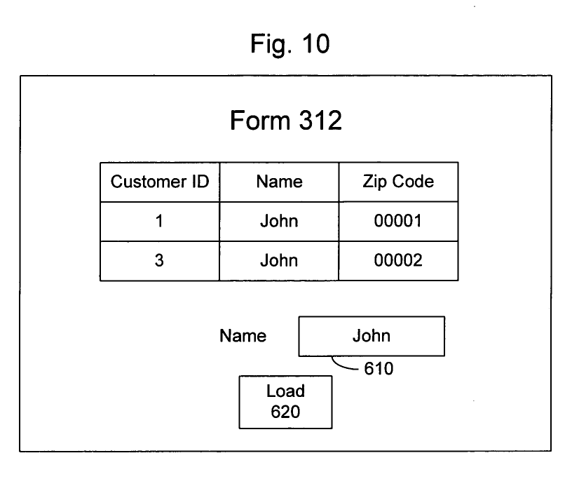

The user may enter the desired name in the parameter input field 610. The user may then load the parameterized query with the set input parameter by clicking “Load” button 620. When the parameterized query is loaded, form 312 is populated with the selected portion of customers dataset 222a. Referring now to FIG. 10, Form 312 has now been populated to include records for all customers with the selected name. As shown, form 312 includes only those records from Table 1 for customers named “John”.

As should be appreciated, form 312 of FIG. 9 may include navigation controls to enable the user to scroll across large datasets. Furthermore, although form 312 includes a grid data display, other data displays such as, for example, a details display are contemplated in accordance with the present invention. Such a details display enables the user to scroll through records individually and to view column entries in individual fields.

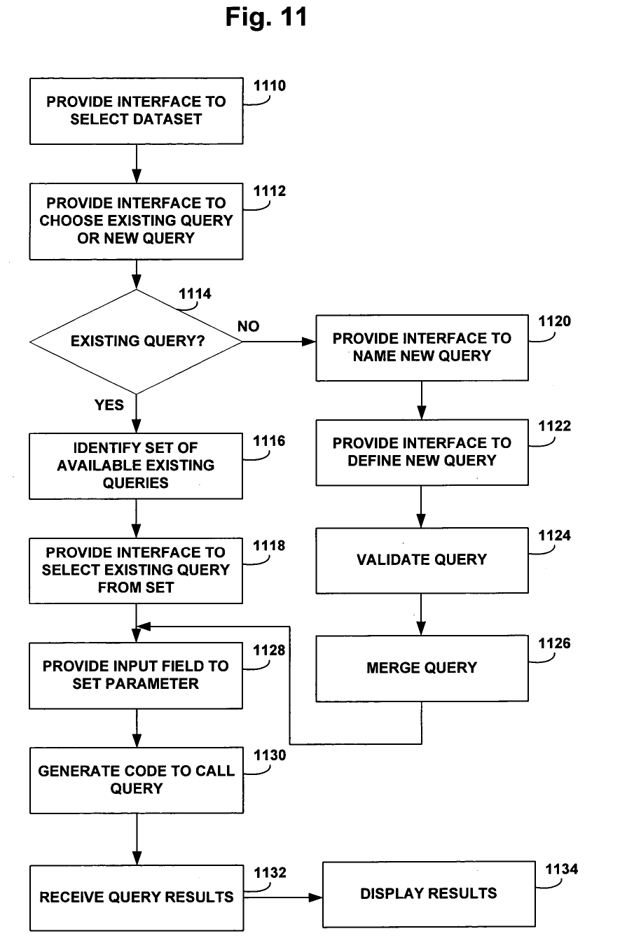

An exemplary method for generating a parameterized query in accordance with the present invention is shown in FIG. 11. The method of FIG. 11 may be initiated by, for example, selecting the parameterized query task set forth above with respect to FIG. 4 or another similar task.

At step 1110, an interface to select a dataset is provided. The interface may be, for example, select dataset drop down menu 510 of FIGS. 5 and 8. Alternatively, the dataset may be automatically identified based on context information. For example, if the parameterized query task is requested from form 312, then Customers dataset 222a may be automatically identified as the dataset because it is the dataset to which form 312 is bound.

At step 1112, an interface to choose whether to select an existing query or define +12Xa new query is provided. The interface may include input fields such as, for example, new query radio button 522 and existing query radio button 532 of FIGS. 5 and 8. At step, 1114 it is determined, based on the interface provided at step 1112, whether the user wishes to select an existing query or to define a new query.

If the user chooses to select an existing query, then, at step 1116, a set of existing queries is identified. The identified set of existing queries is associated with the dataset selected at step 1110. Stored procedures associated with the selected dataset may also be identified. The set of existing queries may be determined by searching a schema metadata file. Such a schema metadata file may be, for example, an extensible markup language (XML) file that stores associated queries and schema information. A default existing query or stored procedure associated with the selected dataset may optionally be identified.

At step 1118 an interface to select an existing query is provided. The interface may be, for example, select existing query drop down menu 530 of FIGS. 5 and 8. The interface may list the queries in the set of existing queries identified at step 1116. The interface may also list any stored procedures identified at step 1116. The default value of the interface may be a default existing query or stored procedure that is identified optionally at step 1116. Each query selected in the interface may be displayed, for example, in a read only input field such as, for example, query input field 550 of FIGS. 5 and 8. The selected existing parameterized query may include any number of input parameters. The selected existing parameterized query may also include zero input parameters if, for example, the user wishes to filter the selected dataset by a constant value that does not change.

If, at step 1114, it is determined that the user chooses to define a new query, then, at step 1120, an interface may be provided to name the existing query. The interface may be, for example, new query name input field 520 of FIGS. 5 and 8.

At step 1122, an interface to define the new query is provided. The interface may be, for example, parameterized query name input field 550 of FIGS. 5 and 8. As set forth above, a sample query structure may also be provided to assist the user in defining the new query. Furthermore, conventional features such as, for example, query builder 570 of FIGS. 5 and 8 may be invoked to provide visual assistance to the user. The new parameterized query may include any number of input parameters. The new parameterized query may also include zero input parameters if, for example, the user wishes to filter the selected dataset by a constant value that does not change.

At step 1124, the new query is validated to ensure that it may be executed upon the selected dataset. For example, the query may be validated by determining that the parameterized portion of the dataset is, in fact, present in the dataset. The syntax of the query may also be validated.

At step 1126, the new query may optionally be added to a set of existing queries that are associated with the selected dataset. The set of existing queries may be stored in the schema metadata file.

At step 1128, input fields to set query parameters are provided. One such input field may be, for example, parameter input field 610 of FIGS. 6, 7, 9, and 10. As should be appreciated, any number of input fields may be provided each corresponding to a query parameter. Furthermore, no input fields may be provided if, for example, the user has chosen to filter the selected dataset by a constant value that does not change. The query input parameters may be type safe parameters, meaning that the type of parameter input is validated prior to executing the query.

At step 1130, code is generated to call the parameterized query. Such code explicitly sets the query parameters to the values, if any, entered in the input fields at step 1128.

At step 1132, query results are received from data source 220, and, at step 1134, a display object in designer 212 such as, for example, form 312 is populated with the query results. The query results may be displayed in, for example, a grid display such as shown in FIGS. 7 and 10. Alternatively, such results may be displayed in a details display as set forth above. The displayed data may be edited and manipulated, and changes made to the data may be propagated back to data source 220 via data source interface 215.

Conclusion

Systems and methods for efficiently generating a parameterized query have been disclosed. A user may select a dataset and choose whether to select an existing parameterized query or to define a new parameterized query to execute upon the selected data source. If the user chooses to select an existing parameterized query, then a set of existing parameterized queries corresponding to the dataset may be identified and presented to the user. If the user chooses to define a new parameterized query, then the new parameterized query may easily be merged into the set of existing parameterized queries corresponding to the dataset. In response to the generation of a parameterized query, input fields may be readily provided that enable the user to set the value of query parameters. Thus, the user may easily and efficiently add searching and filtering capabilities in connection with an application.

While the present invention has been described in connection with the preferred embodiments of the various figures, it is to be understood that other similar embodiments may be used or modifications and additions may be made to the described embodiment for performing the same function of the present invention without deviating therefrom. For example, parameters may be input, output, or input/output in direction. Therefore, the present invention should not be limited to any single embodiment, but rather should be construed in breadth and scope in accordance with the appended claims.

1. A method for generating a parameterized query that includes a query parameter that is set by a user to retrieve selected data from a dataset, the method comprising:
providing an interface that enables the user to select the parameterized query from a set of available parameterized queries associated with the dataset; and
providing an input field that enables the user to set the query parameter.

2. The method of claim 1, further comprising providing an interface that enables the user to select the dataset.

3. The method of claim 1, further comprising identifying the set of available parameterized queries.

4. The method of claim 3, wherein identifying the set of available parameterized queries comprises identifying a default parameterized query associated with the dataset.

5. The method of claim 3, wherein identifying the set of available parameterized queries comprises identifying stored procedures associated with the dataset.

6. The method of claim 1, comprising providing an input field that enables the user to set the query parameter to a constant value.

7. The method of claim 1, further comprising validating that the query parameter is a valid parameter type.

8. The method of claim 1, further comprising generating code for calling the parameterized query including the set query parameter.

9. The method of claim 8, further comprising executing the parameterized query including the set query parameter.

10. The method of claim 1, further comprising generating a data component for executing the parameterized query at a corresponding data source.

11. The method of claim 10, further comprising populating a display object with the results of the executed parameterized query.

12. The method of claim 10, further comprising populating one of a grid control view and a details view with the results of the executed parameterized query.

13. The method of claim 1, further comprising generating a data component for executing the parameterized query against a corresponding data source.

14. A computer readable medium having computer-executable instructions for performing the steps recited in claim 1.

15. A method for generating a parameterized query that includes a query parameter that is set by a user to retrieve selected data from a dataset, the method comprising:
providing an interface that enables a user to define the parameterized query; and
providing an input field that enables the user to set the query parameter.

16. The method of claim 15, further comprising providing an interface that enables the user to select the dataset.

17. The method of claim 15, further comprising generating a sample parameterized query structure including an exemplary query parameter corresponding to a portion of the dataset.

18. The method of claim 15, further comprising validating the parameterized query by determining that the query parameter corresponds to an existing portion of the dataset.

19. The method of claim 15, further comprising storing the parameterized query in a set of parameterized queries associated with the dataset.

20. The method of claim 15, comprising providing an input field that enables the user to set the query parameter to a constant value.

21. The method of claim 15, further comprising validating that the query parameter is a valid parameter type.

22. The method of claim 15, further comprising generating code for calling the parameterized query including the set query parameter.

23. The method of claim 15, further comprising executing the parameterized query including the set query parameter.

24. The method of claim 23, further comprising populating a display object with the results of the executed parameterized query.

25. The method of claim 23, further comprising populating one of a grid control view and a details view with the results of the executed parameterized query.

26. The method of claim 15, further comprising generating a data component for executing the parameterized query against a corresponding data source.

27. A computer readable medium having computer-executable instructions for performing the steps recited in claim 15.

28. A method for generating a parameterized query that includes a query parameter that is set by a user to retrieve selected data from a dataset, the method comprising:
providing an interface that enables the user to choose one of defining a new parameterized query and selecting an existing parameterized query;
if the user chooses to define a new parameterized query, then providing a user interface that enables a user to define the parameterized query;
if the user chooses to select an existing parameterized query, then:
identifying a set of available parameterized queries associated with the dataset; and
providing a user interface that enables the user to select the parameterized query from the set of available parameterized queries; and
providing an input field that enables the user to set the query parameter.

29. The method of claim 28, further comprising providing an interface that enables the user to select the dataset.

30. The method of claim 28, further comprising further comprising generating a sample parameterized query structure including an exemplary query parameter corresponding to a portion of the dataset.

31. The method of claim 28, further comprising validating the parameterized query by determining that the query parameter corresponds to an existing portion of the dataset.

32. The method of claim 28, further comprising storing the new parameterized query in a set of parameterized queries associated with the dataset.

33. The method of claim 28, comprising providing an input field that enables the user to set the query parameter to a constant value.

34. The method of claim 28, further comprising validating that the query parameter is a valid parameter type.

35. The method of claim 28, further comprising generating code for calling the parameterized query including the set query parameter.

36. The method of claim 28, further comprising executing the parameterized query including the set query parameter.

37. The method of claim 36, further comprising populating a display object with the results of the executed parameterized query.

38. The method of claim 28, wherein identifying the set of available parameterized queries comprises identifying a default parameterized query associated with the dataset.

39. The method of claim 28, wherein identifying the set of available parameterized queries comprises identifying stored procedures associated with the dataset.

40. The method of claim 28, further comprising generating a data component for executing the parameterized query against a corresponding data source.
